(19) United States
(12) Patent Application Publication
(10) Pub. No.: US 2024/0263764 A1
(43) Pub. Date: Aug. 8, 2024

(54) CLINICAL WORKSPACE ILLUMINATION SYSTEMS AND DEVICES

(71) Applicant: Lumift Care, Inc., Fresno, CA (US)

(72) Inventors: Jennifferre Mancillas, Fresno, CA (US); Anthony Scarpone-Lambert, Chalfont, PA (US)

(21) Appl. No.: 17/765,638

(22) PCT Filed: Oct. 28, 2021
(86) PCT No.: PCT/US21/56961

§ 371 Date: Mar. 31, 2022

Related U.S. Application Data
(60) Provisional application No. 63/223,284, filed on Jul. 19, 2021.

(51) Int. Cl. F21V 19/00; F21V 17/10; F21V 23/04; F21V 23/06; F21W 131/20; F21Y 113/13; F21Y 115/10

(52) U.S. Cl. CPC F21V 19/003; F21V 17/105; F21V 23/04; F21V 23/06; F21W 2131/20; F21Y 2113/13; F21Y 2115/10

(57) ABSTRACT

Disclosed embodiments may include a system for clinical workspace illumination that includes an illumination device including a housing configured to allow the transmission of light and retain a printed circuit board (PCB). The PCB is electrically coupled to a power supply, a red LED, a white LED, a blue LED; and a button configured to allow an electrical connection with the power supply to sequentially illuminate the red, white, and blue LEDs. An outer shell includes a bridge disposed between a front shell portion and a rear shell portion, wherein the front shell portion is configured to retain the illumination device. The rear shell portion is configured to retain a shell magnet. The shell magnet is configured to be disposed opposite at least another portion of a device magnet disposed within the housing when the front shell portion and the rear shell portion are folded about the bridge.

This application claims the benefit of International Application No. PCT/US2021/056961 filed on Oct. 28, 2021, which claims the benefit of U.S. Provisional Application Ser. No. 63/223,284, filed on Jul. 19, 2021, the contents of each of which is incorporated herein by reference in its entirety.

### FIELD

The disclosed technology relates generally to illumination devices, and more particularly to clinical workspace illumination devices and systems that facilitate more efficient workflows in patient care environments while decreasing patient disruption.

### BACKGROUND

Clinical settings (e.g., hospitals) are not conducive to comfortable, patient-centered experiences. While patient experience is most directly impacted on the frontline, healthcare workers often lack the necessary support needed to deliver the best patient care and safety. For example, healthcare workers are currently unable to easily see when providing care to patients in dark or dimly lit environments, causing them to turn on overhead room lights that disrupt patients' sleep and comfort. In particular healthcare workers are unable to identify lines, electrocardiogram leads, chest tubes, temperature probes, respiratory circuits, and power cords, for example, while creating a sleep-friendly environment for patients.

Sleep deprivation for patients often result in delirium, poorer health outcomes, and declining patient satisfaction, particularly for older patient populations. The equipment currently used (e.g., pen lights, keychain lights, flashlights, phone lights, and wearable lights made for runners and/or bikers) to provide effective lighting and visualization of clinical equipment and patient care materials awakens patients and causes disruption in sleep, which negatively impacts patient health and recovery. Moreover, current illumination tools for healthcare workers are not designed for use in a clinical environment and therefore have a reduced safety profile. In particular, current illumination devices are not capable of hands-free use, cleanable by a hospital grade disinfectant, and/or constructed of antimicrobial materials, among other deficiencies.

### SUMMARY

Disclosed embodiments may include a system for clinical workspace illumination that includes a first housing comprising a front housing portion comprising a translucent insert or a housing aperture configured to allow the transmission of light and a rear housing portion. The housing is configured to retain a printed circuit board (PCB) electrically coupled to a power supply via electrical contacts a plurality of light emitting diodes (LEDs) including at least a red LED, a white LED, and a blue LED disposed proximate the translucent insert or the housing aperture. In some examples, the PCB is also electrically coupled to a button disposed between the electrical contacts and the plurality of LEDs. The button is configured to, when engaged, allow an electrical connection with the power supply to sequentially illuminate the red LED, the white LED, and the blue LED. A device magnet is disposed within the first housing proximate the rear housing portion or coupled to the rear housing portion. The system also includes a shell magnet and an outer shell comprising a bridge disposed between a front shell portion and a rear shell portion. The front shell portion is configured to retain the illumination device and includes a rear aperture for receiving the illumination device. Additionally, the rear shell portion is configured to retain the shell magnet and includes a front aperture for receiving the shell magnet. At least a portion of the shell magnet is configured to be disposed opposite at least another portion of the device magnet when the front shell portion and the rear shell portion are folded about the bridge.

In another aspect, the systems in disclosed embodiments may include an illumination device including a first housing including an adjustable socket The adjustable socket includes an extendable portion coupled to the base and including a LED housing including a translucent cover. A base is coupled to the first housing and configured to allow extension and retraction of the extendable portion and pivot of the extendable portion in a least four directions to facilitate directionality of light transmitted via the translucent cover. The first housing in some examples also includes a plurality of buttons and an LED PCB including a plurality of LEDs including at least a red LED, a white LED, and a blue LED disposed in alignment with the translucent cover. The LED PCB is electrically coupled to a power supply and the plurality of buttons. The plurality of buttons includes at least a red light button, a white light button, and a blue light button configured to, when engaged, allow an electrical connection with the power supply to illuminate the red LED, the white LED, and the blue LED, respectively.

Further features of the disclosed design, and the advantages offered thereby, are explained in greater detail hereinafter with reference to specific embodiments illustrated in the accompanying drawings, wherein like elements are indicated by like reference designators.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is an exemplary illumination system including an illumination device within an outer shell in a closed position, in accordance with certain embodiments of the disclosed technology.

FIG. 2 illustrates the exemplary illumination system of FIG. 1 including the illumination device within the outer shell in an open position, in accordance with certain embodiments of the disclosed technology.

FIG. 3 illustrates electronic components of the exemplary illumination device of FIGS. 1-2, in accordance with certain embodiments of the disclosed technology.

FIG. 4 is a schematic of an exemplary printed circuit board of the electronic components illustrated in FIG. 3, in accordance with certain embodiments of the disclosed technology.

FIGS. 5A-B illustrate an exemplary illumination system including an illumination device with an adjustable socket for directing illumination and within an outer shell in a closed position, in accordance with certain embodiments of the disclosed technology.

FIG. 6 is an exploded diagram illustrating an exemplary assembly of the exemplary illumination device of FIGS. 5A-B, in accordance with certain embodiments of the disclosed technology.

FIGS. 7A-C illustrate exemplary electronic components, including a printed circuit board and associated circuits, of the exemplary illumination device of FIGS. 5A-B and FIG. 6, in accordance with certain embodiments of the disclosed technology.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

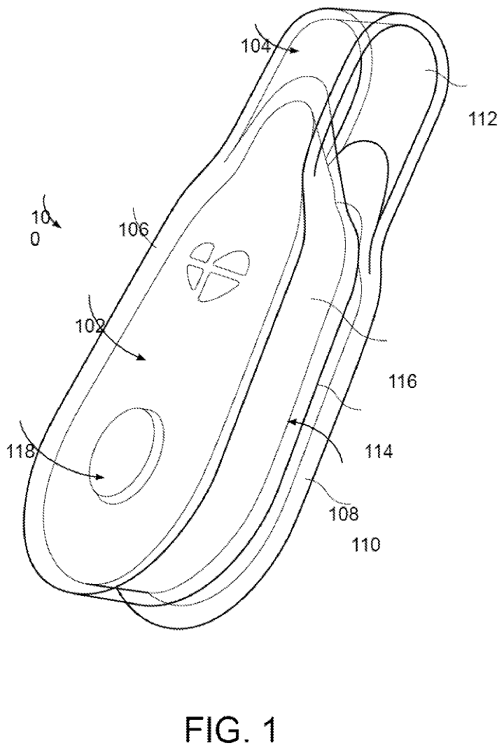

FIG. 1 is an exemplary illumination system 100 including an illumination device 102 within an outer shell 104 in a closed position, in accordance with certain embodiments of the disclosed technology. The illumination device 102 is retained within a front portion 106 of the outer shell 104 and includes a device magnet 108 integral with or coupled to a rear portion of the illumination device. 102. The outer shell 104 includes a rear portion 110 that is coupled to the front portion 106 via a bridge 112 and retains a shell magnet 114 configured to attract the device magnet 108 to facilitate a closed position.

In use, the rear portion 110 with the shell magnet 114 can be inserted into a pocket or another interior portion of clothing (e.g., medical scrubs) or other soft fabric while the front portion 106 with the illumination device 102 is disposed opposite the rear portion 110 with the shell magnet 114 and on the exterior of the clothing. Accordingly, the attraction of the device magnet 108 and the shell magnet 114 in this example, along with the bridge 112, retain the position and orientation of the illumination system 100 with respect to the clothing. In other examples, the illumination system 100 and/or the illumination device 102 can be attached to clothing or another accessory worn by a healthcare worker, for example, to facilitate hands-free use.

The illumination device 102 in this particular example includes a housing 116. Optionally, the shell magnet 114 can also be disposed within a housing that, along with the housing 116, can be acrylonitrile butadiene styrene (ABS) or another thermoplastic polymer, for example, although other materials can also be used. In some examples, a portion, or optionally the entirety, of the illumination device 102 and/or the shell magnet 114 are covered by the outer shell 104, which can be made of a translucent firm silicone that can be exposed to hospital-grade disinfectant and other fluids healthcare workers are exposed to during patient care. Accordingly, in these examples, the outer shell 104 effectively forms a water-tight silicone overlay that is cleanable by a hospital grade disinfectant wipe, stain-resistant, antimicrobial, and liquid-repellant.

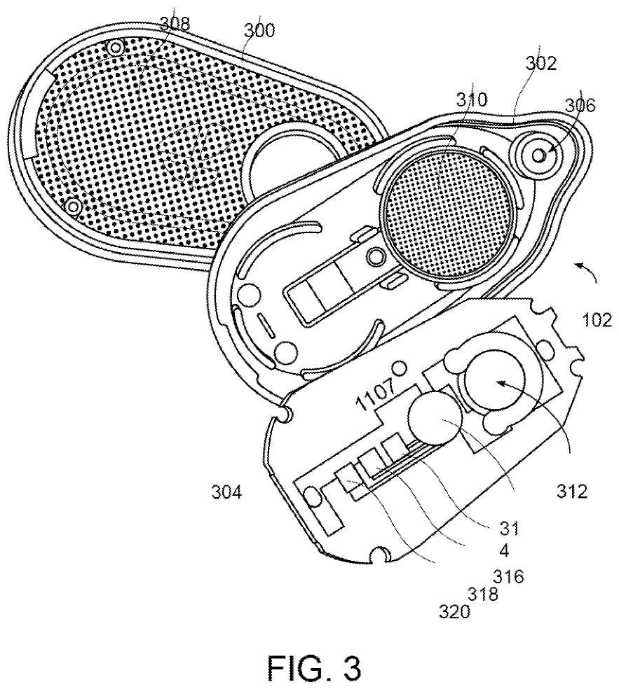

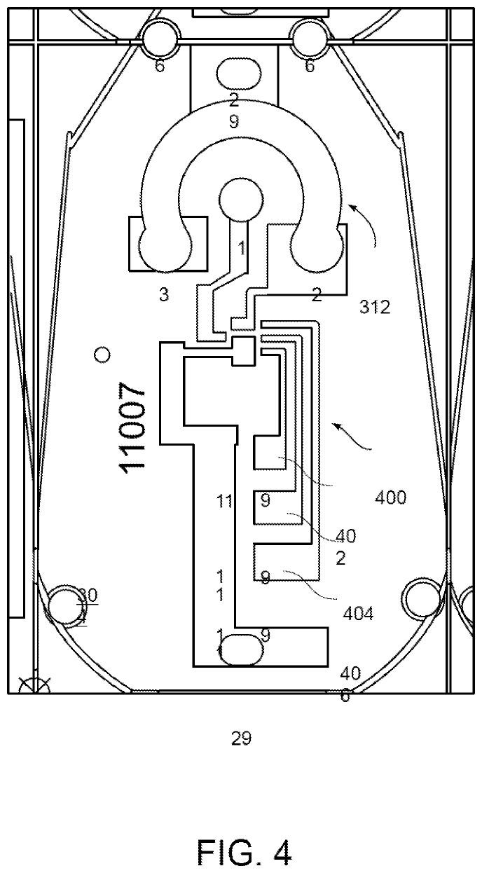

The housing 116 of the illumination device 102 includes an aperture 118 in this particular, example, although the aperture can be a transparent or translucent portion of the housing 116 in other examples. The aperture 118 allows the transmission of light generated in turn by a set of light emitting diodes (LEDs) when the illumination device 102 is in operation, as described and illustrated in more detail below with reference to FIGS. 3-4.

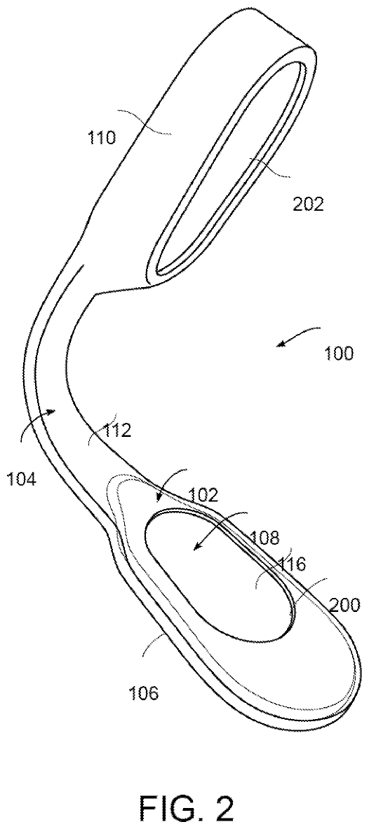

Referring now to FIG. 2, the exemplary illumination system 100 of FIG. 1 is illustrated including the illumination device 102 within the outer shell 104 in an open position, in accordance with certain embodiments of the disclosed technology. In the example illustrated in FIG. 2, the front portion 106 of the outer shell 104 includes a rear aperture 200 that allows for insertion and removal (e.g., for cleaning) of the illumination device 102. Additionally, the rear aperture 200 exposes at least a portion of the device magnet 108. The rear portion 110 of the outer shell 104 includes a front aperture 202 that facilitate insertion and removal (e.g., for cleaning) of the shell magnet 114 (not shown in FIG. 2). The front aperture 202 also exposes at least a portion of the shell magnet 114.

By exposing at least a portion of the device magnet 108 and the shell magnet 114, the rear aperture 200 and the front aperture 202, respectively, facilitate more effective attraction of the device magnet 108 and the shell magnet 114, and corresponding attachment of the illumination system 100. However, the outer shell 104 can fully enclose one or more of the illumination device 102 or shell magnet 114 in other examples, and the illumination system 100 can also be attached for hands-free use in other ways in other examples. In some examples, the dimensions of the illumination device 102 are about 7 cm×3.5 cm×2.5 cm and the weight of the illumination device 102 is about 39 grams, although other sizes and weights can also be used. However, as disclosed in FIGS. 1-2, the illumination system 100 is advantageously relatively light-weight and magnetically attachable, as well as relatively efficient to operate as will now be explained.

FIG. 3 illustrates electronic components of the exemplary illumination device 102 of FIGS. 1-2, in accordance with certain embodiments of the disclosed technology. The housing 116 of the illumination device 102 in this example includes a front housing 300 and a rear housing 302, which are configured to be coupled together to retain a printed circuit board (PCB) 304. In this particular example, the front housing 300 and the rear housing 302 are coupled together via a threaded fastener (not shown) and aperture 306, although other methods of attaching those housings can be used in other examples. The front housing 300 including a translucent insert 308 in this particular example, which allows for the transmission of light, although an aperture 118 can also be provided for that purpose, as described and illustrated above with reference to FIG. 1.

The rear housing 302 retains a power supply 310, such as a battery (e.g., one or more CR2032 batteries), that supplies power to components of the PCB 304 (e.g., via the electrical contacts 312) when the PCB 304 is inserted and retained between the front housing 300 and the rear housing 302. The PCB 304 further includes a button 314 disposed between the electrical contacts 312 and a set of LEDs and configured to selectively allow an electrical connection with the power supply 310 to illuminate one of the LEDs when engaged (e.g., depressed). In this example, the LEDs include a red LED 316, a white LED 318, and a blue LED 320, although another type or color of light source or number of LEDs can also be used in other examples.

In the illumination device 102, the LEDs 316, 318, and 320 are illuminated in sequence (i.e., the red LED 316, followed by the white LED 318, followed by the blue LED 320) based on interaction with the button 314. Optionally, a fourth interaction with the button 314 results in no illumination of any of the LEDs 316, 318, and 320, and other methods for toggling the LEDs 316, 318, and 320 can also be used. The red light output by the red LED 316 facilitates improved night vision preservation and reading and tactile interventions. The white light output by the white LED 318 facilitates improved assessment of color and fluid identification, as well as general physical assessments. Additionally, the blue light output by the blue LED 320 facilitates healthcare worker alertness, orientation, and energy. Additionally, the blue LED 320 allows for improved visualization of specific equipment and patient care materials in the dark when interacting with products that are designed to fluoresce under the illumination of the blue LED 320, for example.

The sequencing of emitted colored light with the illumination device 102 of this technology advantageously ensures healthcare workers are beginning to illuminate their workspace in the least disruptive way possible, while increasing their ability to see in the dark or when in relatively low light conditions. In this particular example, the LEDs 316, 318, and 320 are surface mount LEDs that are mounted to the PCB 304 wherein the red LED 316 is configured to output light that is about 35 lumens and has a wavelength of approximately 633 nm, the white LED 318 is a cool white LED that is configured to output light that is about 30 lumens and has a temperature of approximately 6500K, and the blue LED 320 is configured to output light that is about 30 lumens and has a wavelength of approximately 470 nm, although other types of LEDs or light sources having other quantities of visible light or other wavelengths can also be used in other examples.

FIG. 4 is a schematic of the exemplary PCB 304 of the electronic components illustrated in FIG. 3, in accordance with certain embodiments of the disclosed technology. The PCB in this example includes the electrical contacts 312 that, when in contact with the power supply 310, are configured to selectively (e.g., based on interaction with the button 314) distribute power via conductive tracks 400 to the LEDs via red, white, and blue LED electrical connections 402, 404, and 406, respectively.

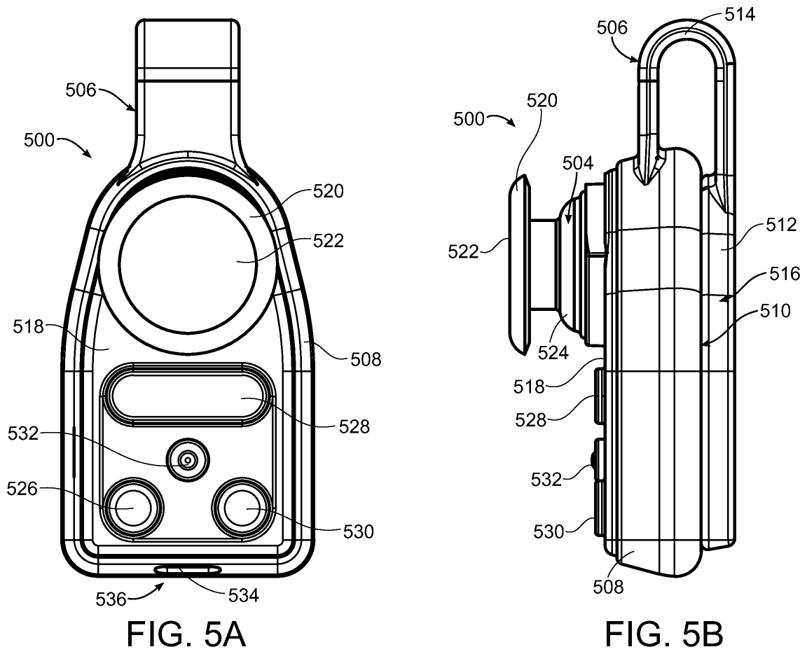

FIGS. 5A-B illustrate an exemplary illumination system 500 including an illumination device 502 with an adjustable socket 504 for directing illumination and within an outer shell 506 in a closed position, in accordance with certain embodiments of the disclosed technology. The illumination device 502 in this example is also retained within a front portion 508 of the outer shell 506 and includes a device magnet 510 integral with or coupled to a rear portion of the illumination device. 502. The outer shell 506 includes a rear portion 512 that is coupled to the front portion 508 via a bridge 514 and retains a shell magnet 516 configured to attract the device magnet 510 to facilitate a closed position.

In use, the rear portion 512 with the shell magnet 516 can be inserted into a pocket or another interior portion of clothing (e.g., medical scrubs) or other soft fabric while the front portion 508 with the illumination device 502 is disposed opposite the rear portion 512 with the shell magnet 516 and on the exterior of the clothing. Accordingly, the attraction of the device magnet 510 and the shell magnet 516 in this example, along with the bridge 514, retain the position and orientation of the illumination system 500 with respect to the clothing. In other examples, the illumination system 500 and/or the illumination device 502 can be attached to clothing or another accessory worn by a healthcare worker, for example, to facilitate hands-free use. Accordingly, the attachment of the illumination device 502 for hands-free use in some examples is substantially the same as described and illustrated above with reference to FIGS. 1-2.

The illumination device 502 in this particular example includes a housing 518. Optionally, the shell magnet 516 can also be disposed within a housing that, along with the housing 518, can be ABS or another thermoplastic polymer, for example, although other materials can also be used. In some examples, a portion, or optionally the entirety, of the illumination device 502 and/or the shell magnet 516 are covered by the outer shell 506, which can be made of a translucent firm silicone that can be exposed to hospital-grade disinfectant and other fluids healthcare workers are exposed to during patient care. Accordingly, in these examples, the outer shell 506 effectively forms a water-tight silicone overlay that is cleanable by a hospital grade disinfectant wipe, stain-resistant, antimicrobial, and liquid-repellant, and the outer shell 506 can therefore be substantially the same as the outer shell 104, although shaped differently to correspond with and retain the illumination device 502 that has a housing 518 of different shape and dimensions than the housing 116 of the illumination device 102.

The adjustable socket 504 is coupled to the housing 518 of the illumination device 502 and includes an extendable portion that includes an LED housing 520 with a translucent cover 522. The LED housing 520 is coupled to a base 524 of the adjustable socket 504 via a spring-loaded retractable mechanism that facilitates retraction and extension of the LED housing 520. Additionally, in some examples, the LED housing 520 is further coupled to the base 524 of the adjustable socket 504 via a pivoting mechanism that is configured to allow the LED housing 520 to pivot with respect to the base 524 in at least four directions (e.g., up, down, left, and right), and maintain the resulting angle, in order to alter the directionality of the light emitted through the translucent cover 522.

Accordingly, a user can push or pull on the LED housing 520 to extend or retract the LED housing 520 and then engage an outer portion of the LED housing 520 to tilt or pivot the LED housing 520 and therefore direct light toward a particular angle or location as desired to improve visualization or a portion of a workspace, for example. The ability of the illumination device 502 to facilitate directionality of the emitted light advantageously helps ensure light is directed toward the exact spot a healthcare worker is providing hands-on care. Additionally, by streamlining or narrowing the direction or scope of the light in a clinical environment, healthcare workers can further ensure patients are not disrupted and patients are more likely to remain asleep comfortably.

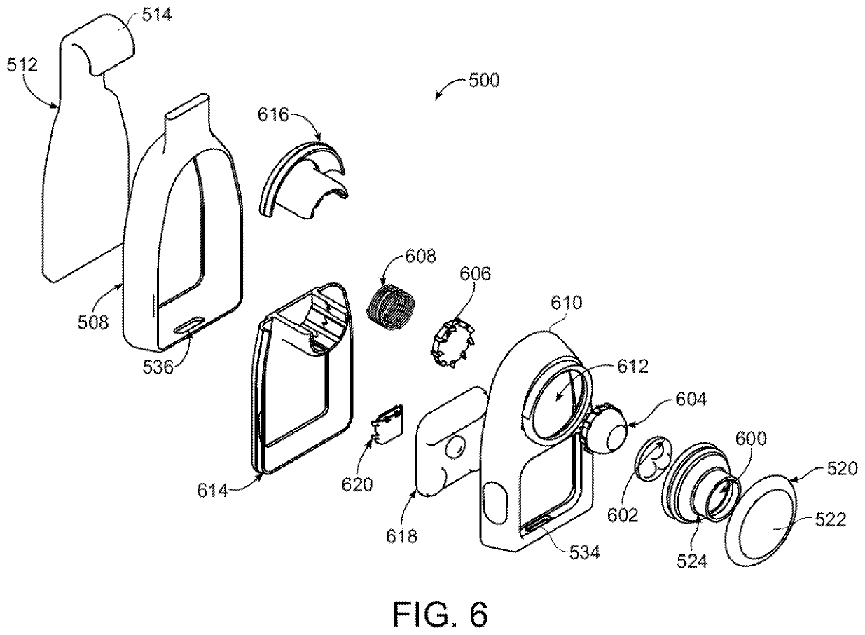

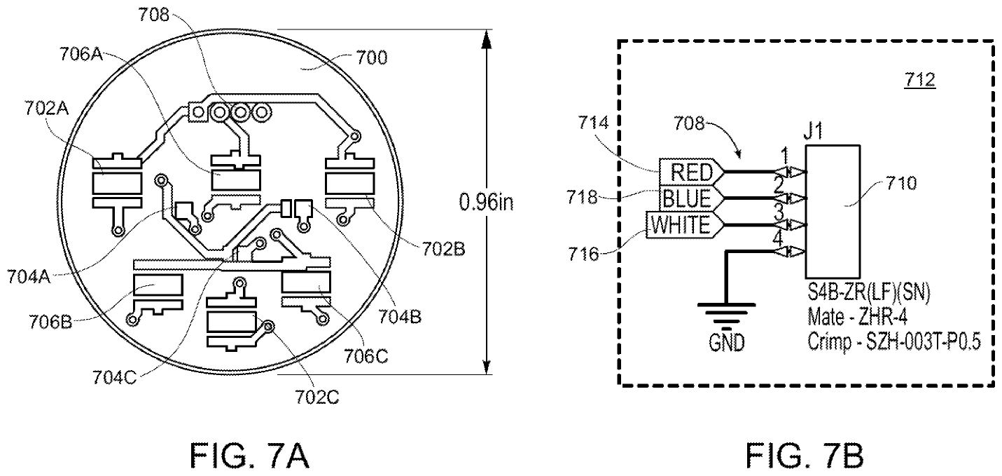

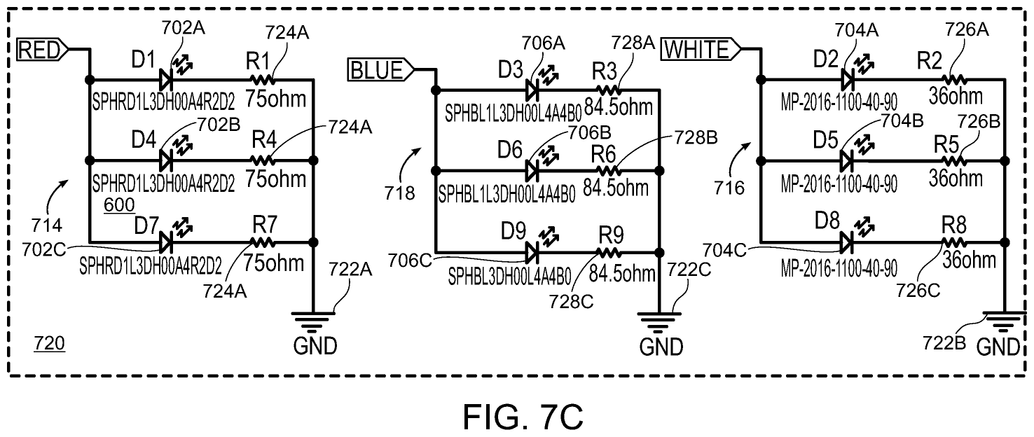

The housing 518 of the illumination device 502 in this example further includes a red light button 526, a white light button 528, and a blue light button 530, which control red, white, and blue LEDs, respectively, that are contained within the LED housing 520, as described and illustrated in more detail below with reference to FIGS. 6 and 7A-C. In this particular example, the white light button 528 is elongated while the red white button 526 and the blue light button 530 are circular and disposed toward opposing sides of the housing 518 and toward a bottom portion of the housing 518 relative to the white light button 528.

An intensity button 532 also is provided in this example, which controls the intensity or brightness of whichever of the colored LEDs are currently illuminated or energized. In one example, each interaction with the intensity button 532 dims or brightens the emitted light by a predetermined level depending on the current direction of the intensity. In another example, the intensity button 532 can be a slider or other type of interface that allows for a particular selection along a spectrum of intensity. Additionally, in some examples, reducing the intensity to zero results in a powering down or turning off of the illumination device 502. In yet other examples, a separate button or switch, for example, is provided to powering the illumination device 502 on and off. While an exemplary button layout is illustrated in FIGS. 5A-B, the control of the emitted light can be of a different form, one or more of the buttons can be in a different location and/or of a different dimension, and other interfaces for controlling the color and/or intensity of the emitted light can also be used in other examples.

Additionally, the housing 518 of the illumination device 502 in this example includes a charging port 534 (e.g., a universal serial bus (USB) port), which can be used to recharge a rechargeable battery or other power supply of the illumination device 502. The charging port 534 is accessible via an aperture 536 in the front portion 508 of the outer shell 506, which in this particular example is disposed toward a bottom portion of the illumination device 502.

Referring to FIG. 6, an exploded diagram of an exemplary assembly of the exemplary illumination device 502 is illustrated, in accordance with certain embodiments of the disclosed technology. As illustrated in FIG. 6, the LED housing 520 with cover 522 is coupled to the base 524, although the LED housing 520 can be integral with the base 524 in other examples. The base 524 has an aperture 600 that allows for light emitted from LEDs to extend through the base 524 toward the cover 522 and subsequently to the ambient environment, such as a clinical workspace. An LED assembly 602 includes one or more LEDs (e.g., red, white, and blue LEDs, a tri-color LED, or a multi-color LED) and is disposed proximate the base 524 such that the LED(s) are capable of directing light through the aperture 600.

The illumination device 502 in this example further includes retractable and/or pivoting mechanism components 604, 606, and 608 that facilitate the extension, retraction, and pivoting, of the LED housing 520. A front portion 610 of the housing 518 includes the charging port 534 and an aperture 612 through which one or more of the retractable and/or pivoting mechanism components 604, 606, and 608 are configured to extend while being coupled to or otherwise retained by a bottom rear portion 614 of the housing 518 and a top rear portion 616 of the housing 518. Accordingly, the front portion 610, bottom rear portion 614, and top rear portion 616 collectively form a frame of the housing 518 and retain a control panel 618, which is coupled to control circuitry 620. The control panel 618 includes the buttons 526, 528, 530, and 532 and the control circuitry 620 contains the electrical connections for one or more of those features.

The illumination system 500 illustrated in FIG. 6 also includes the front portion 508 of the outer shell 506 with the aperture 536 configured to align with the charging port 534 when the housing 518 is received by the front portion 508. Additionally, a rear portion 512 of the outer shell 506 is coupled to the front portion 508 via the bridge 514. While several of the components are illustrated in FIG. 6 as separable, in other examples, one or more of these components can be integral with one or more other components. For example, the front portion 508, bridge 514, and rear portion 512 that collectively comprise the outer shell 506 can be a monolithic silicone structure, and other configurations of any of the components illustrated in FIG. 6 can also be used.

In some examples, the dimensions of the illumination device 502 are about 2.5 cm×6.5 cm×3.7 cm, although other sizes can also be used. Accordingly, the illumination system 500 is advantageously relatively light-weight and magnetically attachable, as well as relatively efficient to operate, which are characteristics shared with the illumination device 102 described and illustrated above. With respect to the operation of the illumination device 502, FIGS. 7A-C illustrate exemplary electronic components, including an LED PCB 700 and associated circuits of the LED assembly 602, in accordance with certain embodiments of the disclosed technology, which will now be described.

The LED PCB 700 in this example includes surface mounted LEDs including red LEDs 702A-C, white LEDs 704A-C, and blue LEDs 706A-C coupled to an interface 708 of a connector 710 to form a connector circuit 712. Three LEDs are provided in this example for each color to facilitate three levels of intensity or brightness (e.g., by illuminating only a subset of LEDs for a particular color based on interaction with the intensity button 532. However, another number of LEDs for one or more of the colors and/or different types of LEDs (e.g., multi-color LEDs) can also be used in other examples. Additionally, the intensity adjustment can also be facilitated in other ways, including by reducing or increasing the intensity for each of a plurality of LEDs for a particular color.

The connector 710 can be coupled to the interface 708 of the LED PCB 700 and can include pins (e.g., four pins (not shown) for receiving an electrical connection (e.g., via wire or plug) that from the red light button 526, white light button 528, and blue light button 530, respectively. Accordingly, the connector 710 facilitates an electrical connection to particular LEDs 702A-C, 704A-C, or 706A-C based on interaction with the red light button 526, white light button 528, and blue light button 530, respectively. Red circuit 714, white circuit 716, and blue circuit 718 of an LED circuit 720 are coupled to the connector 710 via the interface 708. The red circuit 714 includes red LEDs 702A-C coupled to ground 722A via resistors 724A-C, respectively, the white circuit 716 includes white LEDs 704A-C coupled to ground 722B via resistors 7246-C, respectively, and blue circuit 718 includes blue LEDs 706A-C coupled to ground 722C via resistors 728A-C, respectively. Accordingly, in operation, a user can interact with the buttons 526, 528, 530, and 532 of the control panel 618, which is electrically connected to the connector 710, in order to illuminate the LEDs 702A-C, 704A-C, or 706A-C or adjust the intensity of the red, white, or blue light emitted by one or more of the LEDs 702A-C, 704A-C, or 706A-C, respectively.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more components in a device or system does not preclude the presence of additional components or intervening components between those components expressly identified.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for clinical workspace illumination, the system comprising:
an illumination device comprising:
a first housing comprising a front housing portion comprising a translucent insert or a housing aperture configured to allow the transmission of light and a rear housing portion, wherein the housing is configured to retain a printed circuit board (PCB) electrically coupled to:
a power supply via electrical contacts;
a plurality of light emitting diodes (LEDs) comprising at least a red LED, a white LED, and a blue LED disposed proximate the translucent insert or the housing aperture; and
a button disposed between the electrical contacts and the plurality of LEDs, wherein the button is configured to, when engaged, allow an electrical connection with the power supply to sequentially illuminate the red LED, the white LED, and the blue LED; and
a device magnet disposed within the first housing proximate the rear housing portion or coupled to the rear housing portion;
a shell magnet; and
an outer shell comprising a bridge disposed between a front shell portion and a rear shell portion, wherein:
the front shell portion is configured to retain the illumination device and comprises a rear aperture for receiving the illumination device;
the rear shell portion is configured to retain the shell magnet and comprises a front aperture for receiving the shell magnet; and
at least a portion of the shell magnet is configured to be disposed opposite at least another portion of the device magnet when the front shell portion and the rear shell portion are folded about the bridge.

2. The system of claim 1, wherein the outer shell comprises silicone and the bridge, front shell portion, and rear shell portion are integral and monolithic.

3. The system of claim 1, further comprising a second housing configured to retain the shell magnet, wherein the rear shell portion is further configured to retain the second housing, the front aperture is further configured to receive the second housing, and one or more of the first housing or the second housing comprises a thermoplastic polymer.

4. The system of claim 1, wherein the rear aperture exposes the at least another portion of the device magnet and the front aperture exposes the at least a portion of the shell magnet.

5. The system of claim 1, wherein the red LED is configured to output light that is about 35 lumens and has a wavelength of approximately 633 nm, the white LED is configured to output light that is about 30 lumens and has a temperature of approximately 6500 degrees Kelvin, and the blue LED is configured to output light that is about 30 lumens and has a wavelength of approximately 470 nm.

6. A system for clinical workspace illumination, the system comprising:
an illumination device comprising:
a first housing comprising an adjustable socket comprising:
an extendable portion coupled to the base and comprising a light emitting diode (LED) housing comprising a translucent cover; and
a base coupled to the first housing and configured to allow extension and retraction of the extendable portion and pivot of the extendable portion in a least four directions to facilitate directionality of light transmitted via the translucent cover;
a plurality of buttons; and
an LED printed circuit board (PCB) comprising a plurality of LEDs comprising at least a red LED, a white LED, and a blue LED disposed in alignment with the translucent cover; wherein the LED PCB is electrically coupled to:
a power supply; and
the plurality of buttons comprising at least a red light button, a white light button, and a blue light button configured to, when engaged, allow an electrical connection with the power supply to illuminate the red LED, the white LED, and the blue LED, respectively.

7. The system of claim 6, further comprising
a device magnet disposed within the first housing proximate a rear housing portion of the first housing or coupled to the rear housing portion;
a shell magnet; and
an outer shell comprising a bridge disposed between a front shell portion and a rear shell portion, wherein:
the front shell portion is configured to retain the illumination device and comprises a rear aperture for receiving the illumination device;
the rear shell portion is configured to retain the shell magnet and comprises a front aperture for receiving the shell magnet; and
at least a portion of the shell magnet is configured to be disposed opposite at least another portion of the device magnet when the front shell portion and the rear shell portion are folded about the bridge.

8. The system of claim 7, wherein the power supply is rechargeable and the illumination device further comprises a charging port electrically connected to the rechargeable power supply and accessible via a charging aperture in the front shell portion, wherein the charging aperture is configured to align with the charging port when the illumination device is retained by the front shell portion.

9. The system of claim 8, wherein the charging port comprises a universal serial bus (USB) port.

10. The system of claim 6, wherein the base further comprises a base aperture and the LED PCB is further aligned with the base aperture to allow the plurality of LEDs to emit light through the translucent cover via the base aperture.

11. The system of claim 6, wherein the plurality of buttons further comprise an intensity button configured to, when engaged, reduce the intensity or brightness of one or more of the LEDs.

12. The system of claim 11, wherein the white button is larger than the red button and the blue button and the intensity button is disposed between the white button and the blue and red buttons.

13. The system of claim 6, wherein the plurality of LEDs comprise one or more of three red LEDs, three white LEDs, or three blue LEDs.

14. The system of claim 13, wherein the illumination device further comprises an LED assembly comprising the LED PCB and a connector electrically coupled to the LED PCB via a connector interface, wherein the connector is configured to receive an electrical connection from the plurality of buttons.

15. The system of claim 14, wherein the LED PCB further comprises an LED circuit comprising a red circuit, a white circuit, and a blue circuit coupled to the connector, wherein the red circuit comprises the three red LEDs and a first resistor between each of the three red LEDs and a first ground, the white circuit comprises the three white LEDs and a second resistor between each of the three white LEDs and a second ground, and the blue circuit comprises the three blue LEDs and a blue resistor between each of the three blue LEDs and a third ground.
